(19) United States
(12) Patent Application Publication
(10) Pub. No.: US 2017/0316507 A1
(43) Pub. Date: Nov. 2, 2017

(54) UNCERTAIN UTILITY TO IMPROVE PORTFOLIO SELECTION

(71) Applicant: Anish R. Shah, Cambridge, MA (US)

(72) Inventor: Anish R. Shah, Cambridge, MA (US)

(21) Appl. No.: 15/172,502

(22) Filed: Jun. 3, 2016

Related U.S. Application Data
(60) Provisional application No. 62/328,274, filed on Apr. 27, 2016.

(51) Int. Cl. G06Q 40/06

(52) U.S. Cl. CPC G06Q 40/06

(57) ABSTRACT

In one aspect a computer-implemented approach to portfolio selection (1) forecasts covariance matrices with explicit estimates of error, (2) propagates estimates to forecast with explicit error the variance of any linear combination of items (a portfolio), and (3) by augmenting an objection function, improves the realized performance of optimized investment portfolios.

### CROSS-REFERENCE TO RELATED APPLICATIONS

This application claims the benefit of U.S. Provisional Application No. 62/328,274, filed Apr. 27, 2016, which is incorporated herein by reference.

### BACKGROUND

This invention relates to a quantitative approach to use of an uncertain utility to improve a portfolio selection approach, and more particularly as applied to portfolio selection of financial instruments.

In the portfolio selection problem, investors seek to construct a portfolio—allocate or reallocate their money across different assets—in a way that best
1. profits from their beliefs about future performance—how much each asset will increase or decrease in value
2. meets constraints—e.g., limits on the amount invested in a particular asset, economic sector, or geographic region; limits on portfolio turnover
3. considers additional costs—e.g., transaction costs, taxes
4. prefers tower risk (downside or volatility) to greater.

Referring to FIG. 1, conventional financial portfolio selection invokes examining current holdings (which can include cash) 110, one's beliefs about how Investments will perform 120, any constraints or rules 130, beliefs about costs 140, and beliefs about riskiness 150. Considering these in conjunction, one decides 160 what combination of holdings seems best 170.

[Markowitz, 1952] introduced the notion of optimal investment portfolios, allocations that yield the highest expected return at their level of return variance. Common industry practice today is to find, by computer optimization, allocations that maximize the practitioner's believed utility, an aggregated consideration of the concerns previously mentioned—predicted return, variance, transaction costs, taxes, and other aspects subject to constraints, e.g., position limits, maximum turnover.

Referring to FIG. 2, portfolio selection by optimization takes current holdings 210, forecasts of future return 220, constraints 230, models of costs 240, a covariance model to measure risk 250, and a benchmark portfolio 260 serving as a reference. A computer optimizer 270 finds the portfolio that maximizes return less a penalty on (usually benchmark-relative) variance less consideration for costs subject to constraints. Outputs are the maximizing holdings 280 and reports 290.

Solving one problem, computer optimization, created another, identified over three decades ago, e.g., [Jobson and Korkie, 1980], and still present. With the ability to consider every possible configuration and weigh information in a way humans can't, computers follow inputs to find maxima in odd or extreme configurations. Structured around fully trusted, unavoidably inaccurate estimates, optimized portfolios don't achieve the criteria that, misperceived, led to their creation.

Strategies are employed to mitigate the problem. In practice, most common is to pre-condition, then proceed with conditioned point estimates as if they were true, e.g., [Black and Litterman, 1992], [Ledoit and Wolf, 2003].

Another strategy, from U.S. Pat. No. 6,003,018 [Michaud and Michaud, 1990], is to 1—simulate data under the point estimated parameters (mean and covariance), 2—reinfer parameters from the simulated, data, 3—construct a portfolio from these parameters, 4—repeat the process many times, and in the end, 5—take some sort of average of the constructed portfolios.

A third strategy, called robust optimization, e.g., [Goldfarb and Iyengar, 2003], ventures beyond point estimates: parameters fall, within a confidence range; optimization seeks the portfolio that has the best worst case. However, the complicated optimization—maximum of minimum—rigidly depends on special cases, e.g., see flowchart ‘FIG. 3’ of U.S. Pat. No. 7,401,041 B2 [Goldfarb and Iyengar, 2008].

### Conventional Factor Model Covariance and Portfolio Selection

Conventional practice models the covariance matrix of stock returns and prices that appears throughout the investment process—e.g., forecasting portfolio risk, hedging, algorithmic trading, constructing portfolios via computer optimization—via factors.

Because there are too many securities to accurately infer the many pairwlse entries, covariance models are bulk on a skeleton of common factors, e.g., market, industry, and growth/value spread. Covariance between securities happens only through links to these factors. Movement uncorrelated with factors is called specific. The standard model has three parts, all estimated: covariance of factors, sensitivities (exposures) to factor movements, and variance of specific movements.

A simple example in the flavor of CAPM: Suppose there were only 1 factor, market return. The covariance of the factors would be (1×1), the variance of the market. A stock's exposure to the factor would be the stock's beta, inferred, among other ways, by OLS regressing the stock returns against market returns, or allowing for dynamics, by Kalman filter. The residual errors unexplained by the market would be the stock's specific movement.

More generally, covariance between N items is represented using K factors as:

(N×N) covariance C=EFE^{T}+Diag[ε²] (1)
where F=(K×K) covariance between factors
E=(N×K) exposures to factors
ε²=(N×1) specific variances

[Chan et. al, 1999] compares several standard methods of constructing these. All in the end yield a point estimate of the covariance matrix.

A portfolio, a linear combination of items, has modeled variance:

Var[w₁×item 1+ . . . +w_{N}×item N]=w^{T}Cw (2)

=w^{T}(EFE^{T}+Diag[ε²])w (3)
where w=(N×1) portfolio weights or holdings

Referring to FIG. 3, in a conventional factor covariance model, a vector of portfolio holdings 310 is combined with the covariance model 320 to generate a portfolio variance number 340. The calculations 330 are equation (3).

Adding estimates of future returns, α, and a risk aversion, λ, leads to a basic form of portfolio selection by optimization, in this case solved by quadratic programming:

maximize_{w} return (w)−λ×variance(w) (4)

=α^{T}w−λw^{T}(EFE^{T}+Diag[ε²])w (5)

Additional terms and constraints, depending on their shape, can change the solving algorithm, e.g., to nonlinear programming.

Referring to FIG. 4, in conventional portfolio selection by optimization, current holdings, the utility function, and its ingredients—forecasts of mean future returns and transaction costs, perhaps a benchmark e.g., S&P500—and constraints 410 are passed to an optimizer 430. The optimizer maximizes utility, with the portfolio variance term 450 in the utility function being a point estimate from the covariance model 420 (a collapse of FIG. 3) applied to the portfolio 440. Optimization yields optimal holdings 460 and the value of optimal utility 470.

This conventional method ignores that inputs are imperfect forecasts. The present invention improves realized performance by altering the utility function to explicitly consider accuracy.

### REFERENCES

[Black and Litterman, 1992] Black, F. and Litterman, r. (1992). Global portfolio optimization. Financial Analysts Journal, 48(5):28-43.

[Chan et al., 1999] Chan, L. K., Karceski, J., and Lakonishok, J. (1999). On portfolio optimization: Forecasting covariances and choosing the risk model. Review of Financial Studies, 12(5):937-974.

[Goldfarb and Iyengar; 2003] Goldfarb, D. and Iyengar, G. (2003). Robust portfolio selection problems. Mathematics of Operations Research, 28(1): 1-38.

[Goldfarb and Iyengar; 2008] Goldfarb, D. and Iyengar, G. (2008). Systems and methods for providing robust investment portfolios. Patent. U.S. Pat. No. 7,401,041B2.

[Jobson and Korkie, 1980] Jobson, J. D. and Korkie, B. (1980). Estimation for markowitz efficient portfolios. Journal of the American Statistical Association, 75(371):544-554.

[Ledoit and Wolf, 2003] Ledoit, O. and Wolf, M. (2003). Improved estimation of the covariance matrix of stock returns with an application to portfolio selection. Journal of empirical finance, 10(5):603-621.

[Markowitz, 1952] Markowitz, H. (1952). Portfolio selection. The Journal of Finance, 7(1):77-91.

[Michaud and Michaud, 1999] Michaud, R. O. and Michaud, R. (1999). Portfolio optimization by means of resampled efficient frontiers. Patent. U.S. Pat. No. 6,003,018 A.

[Shah, 2015] Shah, A. R. (2015). Uncertain covariance models (previously titled incorporating estimates of error into linear factor covariance models). Available at SSRN 2616109.

### SUMMARY

The approach presented herein addresses the estimation error problem with a new tool: uncertain utility. The approach provides improvement over previous approaches, for instance as described in U.S. Pat. No. 6,003,018 [Michaud and Michaud, 1999], at least because it moves beyond point estimates and explicitly considers estimates of accuracy. The approach is an improvement over U.S. Pat. No. 7,401,041 B2 [Goldfarb and Iyengar, 2008], at least because it propagates uncertainty to the consequences of importance, portfolio variance and utility, which can be optimized beyond special cases.

As introduced above, current techniques that assume that the estimates E, F, and ε that make up a covariance model can be treated as the true values in forecasting covariance and determining an optimal portfolio weighting essentially ignore the fact that there is uncertainty in these estimates, and the conventional techniques of the type described above do not take into account the uncertainty.

Some quantities are forecasted more accurately than others, and considering accuracy improves decision making. There is a need to be able to account for the variability in a computationally efficient manner in order to be able to make timely and accurate predictions that are useful for selection of portfolios.

In one aspect, in general, the approach to portfolio selection provides an easily constructed, and communicated means to model uncertain covariance between securities and forecast the mean and variance of portfolio variance.

The ability to do this for any indeterminate portfolio permits penalizing the uncertainty of utility in optimization to better realize the skill in forecasting and mitigate the problem of errors in estimates.

In one aspect, in general, a computerized system for portfolio selection uses quantifications of uncertainty of variance (risk) estimates. The system includes an input for accepting a specification of a plurality of financial instruments, the specification of each instrument including a first quantity representing a variance of a rate of return, and a second quantity representing an uncertainty in the first quantity, a computation module configured to determine weights to apply to the financial instruments to form a portfolio, wherein determining the weights includes optimizing a utility function that depends on both the first quantity and the second quantity for each of the financial instruments, and an output for providing the weights of the portfolio to a user.

### DESCRIPTION OF DRAWINGS

FIG. 1 is an example of the portfolio selection problem.

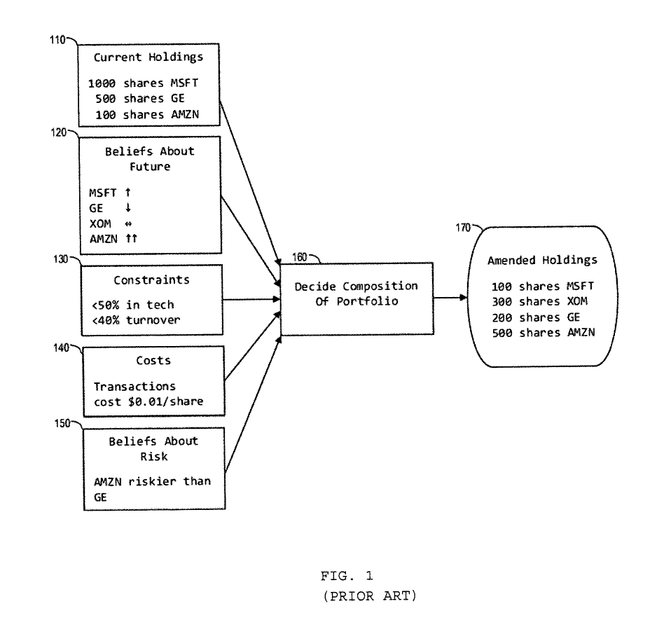

FIG. 2 is an example of portfolio selection via portfolio optimization.

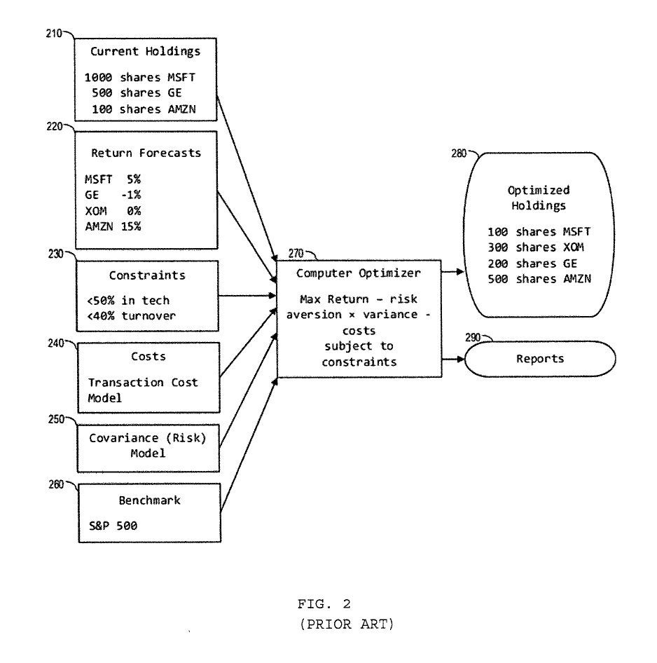

FIG. 3 is a diagram demonstrating the inputs and outputs of portfolio variance calculation using a conventional covariance model.

FIG. 4 is a conventional portfolio selection approach.

FIG. 5 is a diagram demonstrating the inputs and outputs of portfolio variance calculation using an uncertain covariance model.

FIG. 6 is a novel portfolio selection approach.

FIG. 7 is a diagram demonstrating how to build a simple uncertain covariance model.

FIG. 8 is a diagram of a portfolio selection system that considers uncertainty.

### DETAILED DESCRIPTION

In one embodiment, a computer-based system provides a user with a way to select a portfolio. In some implementations, the system is implemented on a computer that the user directly accesses (e.g., a Personal Computer), while in other implementations, the user accesses a computer that is remote from the user, for example, over a data network. In either case, the system makes use of a software-controlled, processor with instructions stored on a non-transitory machine-readable medium. As will be evident through the description below, the approach goes well beyond a mere automation of a conventional approach. That is, for instance, use of an uncertain covariance is not a long-prevalent or fundamental economic practice. Furthermore, as can be appreciated based on the description below, the approach cannot be performed mentally in a short enough time sufficient to make use of the result, and is therefore made possible via a computer-based implementation. That is, even if one could mentally perform the computational steps, such a “pencil and paper” mental process would not meet the need to select, a portfolio in a practical timeframe.

While the conventional covariance model presented above yields only point estimates, uncertain covariance models include additional data for the uncertainty in the individual pieces making up the model. These data make it possible to calculate both the expected value and uncertainty variance of a portfolio's variance.

The conventional model has assumed accurate exposures E, stock-specific standard deviations ε, and factor covariance F. The uncertain covariance model regards these as inferences and uses explicit estimates of inaccuracy: E has estimated mean Ê and covariance \hat{X}. ε has mean \hat{ε} and variance \hat{ω}. F is factored into F=M Diag[θ]M^{T} where θ has mean \hat{θ} and covariance \hat{Ω}, and M has mean \hat{M} and covariance \hat{Γ}. Setting a variance estimate to 0 makes the corresponding piece be regarded as certain, for example, if its uncertainty isn't available.

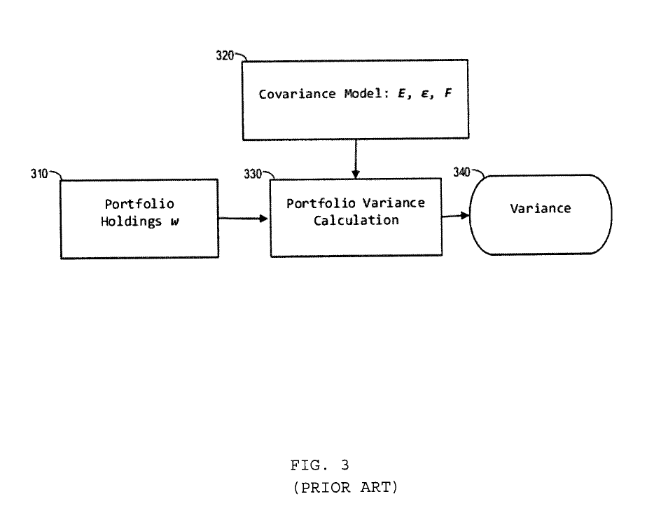

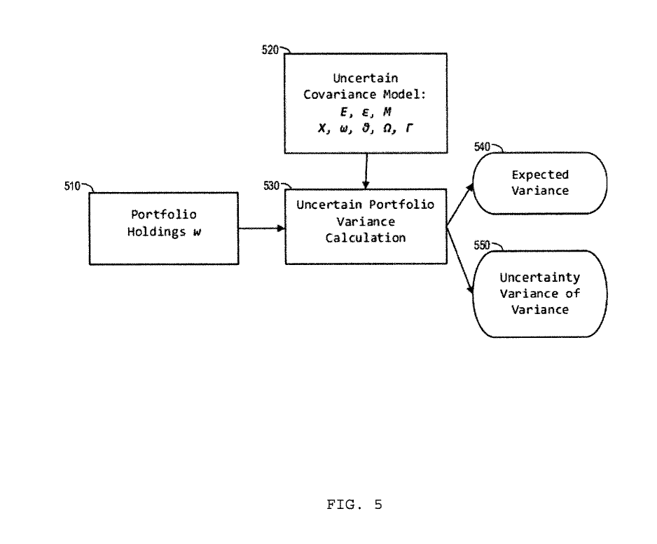

Referring to FIG. 5, to estimate the variance of a portfolio in the uncertain covariance model—analogous to the conventional model's FIG. 3—a vector of portfolio holdings 510 is combined with the uncertain covariance model 520 to generate both the mean 540 and variance 550 of portfolio variance. The calculations 530 are equations (22) and (23) of the Appendix.

Consider again as an example of portfolio utility for portfolio selection, the basic utility function:

U(w)=α(w)−λν(w) (6)

where

α(w)=E[r(w)] (7)

ν(w)=Var[r(w)] (8)

w=absolute or benchmark relative portfolio weights (9)

λ=investor's risk aversion (10)

r(w)=return of portfolio with weights w (11)

Assembling quantities known only through estimates, utility U(w) is uncertain. Uncertain covariance models' ability to propagate uncertainty to the mean and variance of the variance of an indeterminate portfolio permits a new utility:

E[U(w)]−κ×Stdev[U(w)] (12)

where κ is uncertainty aversion. With κ>0, optimization seeks portfolios high in utility and low in uncertainty of utility. The less frequently one rebalances, the greater one's aversion to uncertainty.

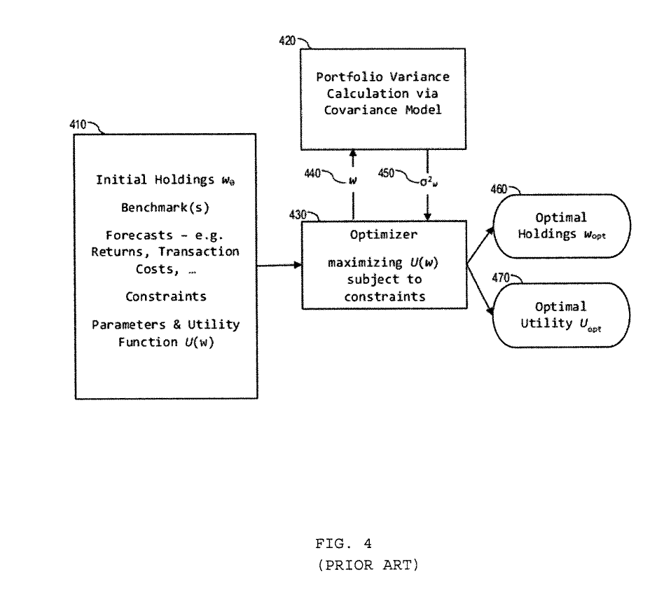

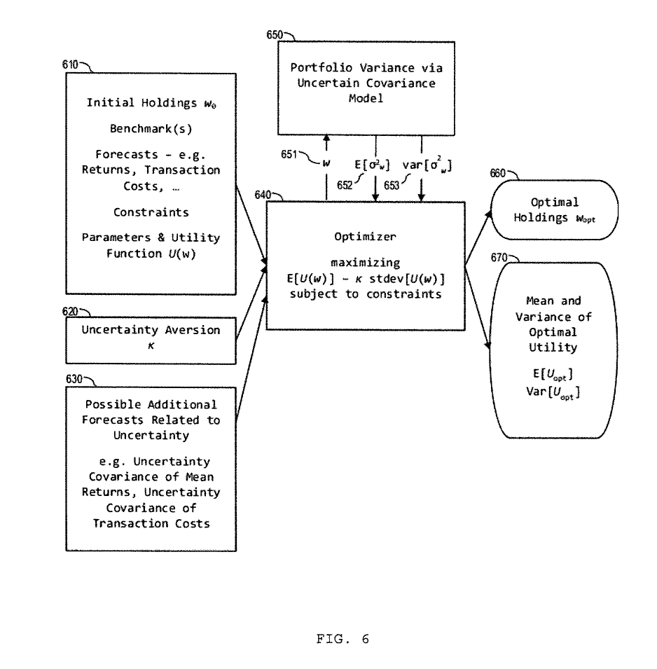

An approach of penalizing uncertainty is applied to the real-world conventional portfolio selection problem of FIG. 4. Referring to FIG. 6, all the conventional's information 610 is supplied. Additional data are the uncertain covariance model, an aversion to uncertainty 620, and optional uncertainty information about any terms, beyond covariance, that should be modeled as inexact 630. The optimizer 640 maximizes expected utility minus uncertainty aversion times the standard deviation of utility. This objective is made possible by the variance forecasts—expectation 652 and uncertainty variance 653—of the portfolio 651 via the uncertain covariance model 650 (a collapse of FIG. 5). Optimization yields optimal holdings 660 and the expected value and variance of optimal utility 670.

For the basic utility of equation (6) above,

Var[U(w)]=λ²Var[ν(w)]+Var[α(w)]−2λCov[α(w), ν(w)] (13)

=λ²Var[ν(w)]+Var[α(w)]−2λρ[α(w), ν(w)]Stdev[α(w)]Stdev[ν(w)] (14)

The first term comes from equation (23) of the Appendix. The second term captures the different bets used to forecast the mean return. It can be ignored or, modeling α as Gaussian with covariance Σ:

Var[α(w)]=w^{T}Σw (15)

The third term, unless modeled, would be assumed 0.

Other terms added to the basic utility of equation (6)—e.g., for transaction costs—can be similarly incorporated:

$$\begin{matrix}If U ( w ) = {\sum }_{i}^{ } {f}_{i} ( w ) , & ( 16 ) \\ Var [ U ( w ) ] = {\sum }_{i}^{ } Var [ {f}_{i} ( w ) ] + 2 {\sum }_{i < j}^{ } Cov [ {f}_{i} ( w ) , {f}_{j} ( w ) ] & ( 17 )\end{matrix}$$

Anything that has an explicit model of uncertainty variance—e.g., uncertain covariance, Gaussian, mean returns—is counted in the first set of terms. What lacks a model is assumed 0. The second set of terms, for covariance, are assumed 0 unless explicitly modeled.

The uncertain utility function, equation (12), is continuous, nonlinear, non-concave, and with local maxima. A global maximum can be sought via general purpose appropriate optimization algorithms, e.g., simulated annealing, genetic algorithms, for instance available as a non-linear convex optimization software (e.g., in a programming language such as C++, Java, R, or Python).

Ad-hoc, the uncertainty term can be turned off (κ=0), the simpler optimization solved by a specialized algorithm exploiting structure, e.g., quadratic programming, and the solution used, with the uncertainty term returned, as an initial search point for a local maximum.

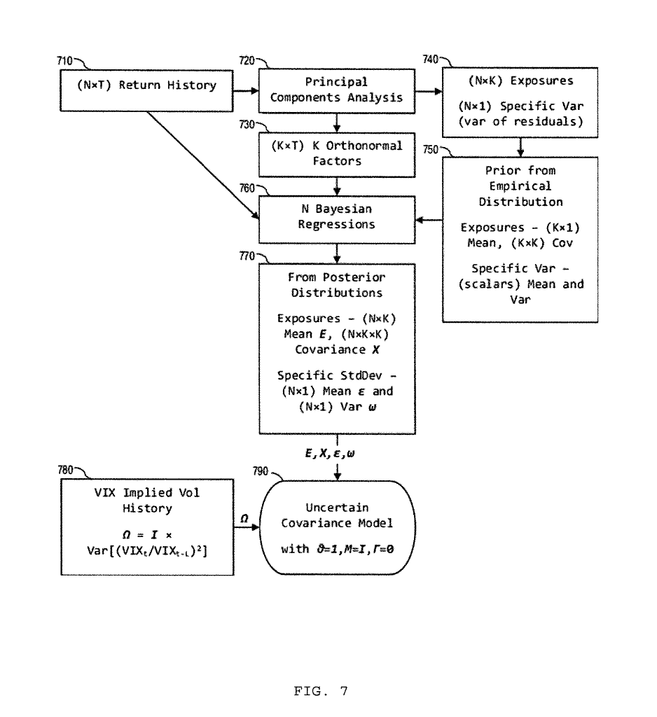

Operation of the computerized system for portfolio selection can be further understood based on the following example. First, a simple uncertain covariance model is built as follows: Referring to FIG. 7, time series of returns from N investments 710 are processed through principal components analysis 720 resulting in K orthonormal factors 730 and exposures to the factors and specific variances 740. The empirical mean and covariance of exposures and of specific variances yields a prior 750. Using the prior, the investment returns 710 are Bayes regressed against the factors 730 yielding expected mean and covariance of exposures and specific standard deviation 770. (Here, \hat{X} is (N×K×K) rather than (N×N×K×K) because between investment exposure uncertainty covariance is 0.) To estimate the uncertainty of factor variances, all factors are assumed to have uncorrelated uncertainty of the same magnitude, which is estimated by the variance of market variance (proxied by the implied volatility index VIX squared) relative to its value L periods lagged 780, where L matches the desired horizon of the model. Set \hat{M}=I since the fetors are already othonormal, assume \hat{M}'s uncertainty \hat{Γ} is 0, and set \hat{θ} to 1. With 770 and 780, this constitutes an uncertain covariance model 790.

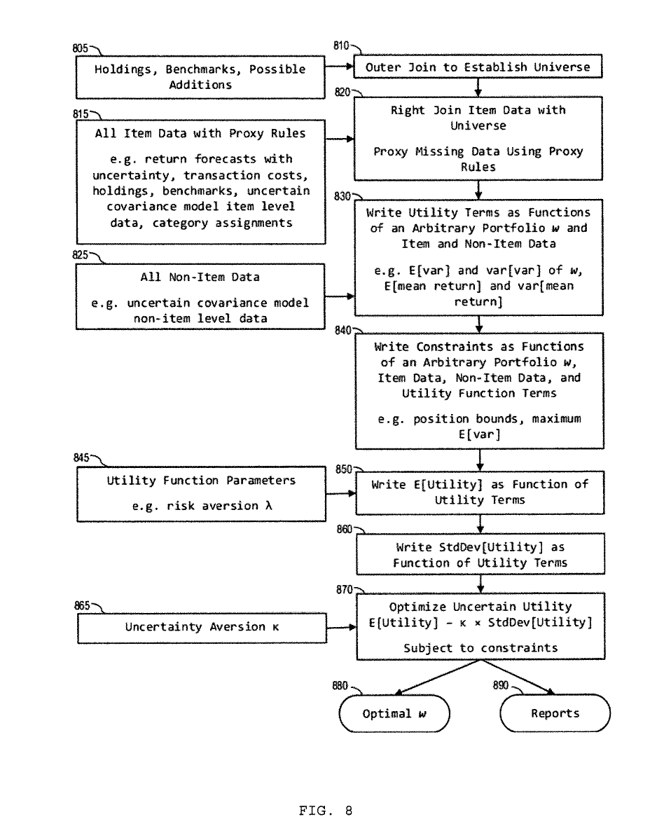

The model can then be used to perform portfolio selection considering uncertainty. Referring to FIG. 8, the investment items to be analyzed 805 are collected to form a universe 810. Item data with proxy rules for missing entries 815 is compared against the universe. Missing entries are proxied according to the rules—e.g., substitute 0. the universe median, or the record for a particular security; discard and reweight other securities—to form a foil organized set of necessary item data 820. Non-Item data—e.g., the uncertainty variance of factors in the uncertain covariance model—825 enters, and the terms appearing in the optimized objective are written as functions of an arbitrary portfolio and the Item and non-item data 830. Constraints 840 are written as functions of the same and the objective function terms. Utility function parameters 845 are added, and expected utility is written as a function of the utility terms 850. The standard deviation of utility is also written as a function of utility terms 860. The uncertainty aversion parameter κ 865 determines the weight given to standard deviation of utility in the objective—expected utility—κ×standard deviation of utility—which is maximized 870 by changing the portfolio weights subject to constraints. The outputs are the optimizing portfolio weights 880 and reports 890.

The numerical approaches described in this document can be implemented, for example, using a programmable computing system executing suitable software instructions or they can be implemented in suitable hardware such as a field-programmable gate array (FPGA) or in some hybrid form. For example, in a programmed approach the software may include procedures in one or more computer programs that execute on one or more programmed or programmable computing systems (which may be of various architectures such as distributed, client/server, or grid) each including at least one processor, at least one data, storage system (including volatile and/or non-volatile memory and/or storage elements), at least one user interface (for receiving input using at least one input device or port, and for providing output using at least one output device or port). The software may include one or mom modules of a larger program, for example, that provides services related to the design, configuration, and execution of dataflow graphs. The modules of the program (e.g., elements of a dataflow graph) can be implemented as data structures or other organized data conforming to a data model stored in a data repository.

The software may be stored in. non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CO-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FFGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the claims. Accordingly, other embodiments are also within the scope of the following claims. For example, various modifications may be made without departing from the scope of the invention. The claims are specifically limited to those embodiments that are within the ambit of 35 USC 101 as of the filing date of this application. To the extent claims are deemed to cover embodiments that are outside the ambit of 35 USC 101, those embodiments are specifically disclaimed. To the extent the claims are deemed to cover embodiments that are no more than software per se, those embodiments are specifically excluded from the claims.

What is claimed is:

1. A computerized system, for portfolio selection using quantifications of uncertainty of variance estimates, the system comprising:
an input for accepting a specification of a plurality of financial instruments, the specification including first quantities representing a variance of a return or price level of each of the financial instruments and relationships of covariance of return or price level between different financial instruments, and second quantities representing uncertainties in the first quantities and relationships of the uncertainties between different quantities of the first quantities;
a computation module configured to determine weights to apply to the financial instruments to form a portfolio, wherein determining the weights includes optimizing a utility function that depends on both the first quantity and the second quantity for each of the financial instruments; and
an output for providing the weights of the portfolio to a user.

2. The system of claim 1 wherein determining the weights of the portfolio comprises:
forming the first quantities to include an estimate of exposures of N financial instruments to K factors as an N×K matrix Ê, and a representation of an estimate of a K×K covariance matrix \hat{F} of the K factors;
forming the second quantities to include a covariance of the exposures as an (N×K)×(N×K) matrix \hat{X}, and a representation of a (K×K)×(K×K) covariance matrix of the entries of \hat{F}.

3. The system of claim 1 wherein determining the weights of the portfolio comprises:
forming the first quantities to include an estimate of exposures of N financial instruments to K factors as an N×K matrix Ê, and an estimate of a K×K covariance matrix \hat{F} of the K factors represented as the product of a K×K matrix \hat{M}, a K×K diagonal matrix with entries \hat{θ}₁ . . . \hat{θ}_{K}, and \hat{M}^{T}; forming the second quantities to include an uncertainty covariance of the exposures as an (N×K)×(N×K) matrix \hat{X}, and a (K×K)×(K×K) uncertainty covariance of the entries of \hat{F} represented via a (K×K)×(K×K) uncertainty covariance matrix \hat{Γ} of the entries of \hat{M} and a K×K uncertainty covariance of the diagonal entries \hat{θ}₁ . . . \hat{θ}_{K}, contained in a possibly larger matrix \hat{Ω}.

4. The system of claim 3 wherein determining the weights of the portfolio further comprises using the formed first quantities and second quantities to define a computation that depends on an expected value of a utility E[U] and an uncertainty standard deviation of the utility Stdev[U], and optimizing the weights according to the expected value of the utility and the standard deviation of the utility.

5. The system of claim 4 wherein optimizing the weights is further according to a utility that represents a combination of an expected value of a return of a portfolio computed according to the weights and a variance of said return.

8. A method for portfolio selection comprising:
accepting data representing a .history of returns or price levels of a set of N financial instruments;
forming a representation of the covariance (C) of the returns or price levels of said financial Instruments;
representing the covariance CO in terms of a covariance of a set of K factors K≦N, and exposures of each of the financial Instruments to each of the factors;
representing the K factors as linear combinations (M) of orthonormal factors, and the K×K covariance of the factors in terms of M and orthonormal factor variance scalars θ₁ . . . θ_{K};
determining estimates of uncertainty of the exposures to the factors and of the terms of the covariance of the factors;
defining a computation of a utility of a portfolio formed of a weighting of the financial instruments according to a set of N weights (ω), the utility of the portfolio depending on the weights an depending on a variance of a return of the portfolio computed according to the weights;
optimizing the weight according to combination of an expected value of the utility and a standard deviation of said utility; and
selecting a portfolio of the set of financial instruments according to weights resulting from the optimization.

7. The method of claim 6 where in the utility of the portfolio represents a combination of an expected value of the return of the portfolio computed according to the weights and the variance of said return.

8. The method of claim 6 wherein optimizing the weights includes repeatedly selecting the weights, computing the combination of the expected value of the utility and the variance of the utility, and updating the weights.

9. Software stored on a non-transitory machine-readable medium having Instructions stored thereupon, the instructions when executed by a data processing system perform a portfolio selection procedure comprising:
accepting data representing a history of returns or price levels of a set of N financial instruments;
forming a representation of the covariance (C) of the returns or price levels of said financial instruments;
representing the covariance (C) in terms of a covariance of a set of K factors K≦N, and exposures of each of the financial instruments to each of the factors;
representing the K factors as linear combinations (M) of orthonormal factors, and the K×K covariance of the factors in terms of M and orthonormal factor variance scalars θ₁ . . . θ_{K};
determining estimates of uncertainty of the exposures to the factors and of the terms of the covariance of the factors;
defining a computation of a utility of a portfolio formed of a weighting of the financial instruments according to a set of N weights (ω), the utility of the portfolio depending on the weights an depending on a variance of a return of the portfolio computed according to the weights;
optimizing the weight according to combination of an expected value of the utility and a standard deviation of said utility; and
selecting a portfolio of the set of financial instruments according to weights resulting from the optimization.
